(19) United States
(12) Patent Application Publication
(10) Pub. No.: US 2004/0103190 A1
(43) Pub. Date: May 27, 2004

(54) Apparatus, system and method for supporting computer users

(76) Inventors: Kunihiko Mochizuki, Tokyo (JP); Akitoshi Morita, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/391,658

(22) Filed: Mar. 20, 2003

(30) Foreign Application Priority Data
Mar. 25, 2002 (JP) 2002-082537
Mar. 25, 2002 (JP) 2002-082538
Jan. 30, 2003 (JP) 2003-021340

(51) Int. Cl. G06F 15/173; G06F 17/00

(52) U.S. Cl. 709/224; 707/104.1

(57) ABSTRACT

A system for supporting computer users is provided with a user's personal computer for which support information is provided, a server for supporting computer users which provides the support information about the user's personal computer, Internet which enables the server for supporting computer users and the user's personal computer to communicate to each other by connecting both of them and a provider for connecting the user's personal computer with the Internet. The system for supporting computer users can accurately and promptly carry out proper measures and/or user support in case of failure, setup of the user's personal computer, and/or installation of an application, and so on.

### FIELD OF THE INVENTION

This invention relates to a server for supporting computer users, a system for recognizing configurations, a system for supporting computer users, a method for recognizing configurations and a method for supporting computer users, in which a configuration of software and/or hardware of a computer system is recognized and user support is carried out. In particular, this invention relates to a server for supporting computer users, a system for recognizing configurations, a system for supporting computer users, a method for recognizing configurations and a method for supporting computer users, in which user support is carried out in accordance with a recognized configuration of software and/or hardware of a user's computer system.

### BACKGROUND OF THE INVENTION

In recent years, the type and/or function of software also became various with the improvement of hardware resources of the computer system, and a variety of applications would have been installed in a computer system.

In this type of computer system, a great number of manufacturers exist at each component of hardware, and it is possible to make a computer system by combining some components in various combination. In addition, a great variety of applications that have the identical function also exist, and it is possible for computer users to decide which applications to utilize.

In such a situation, manufacturers providing software and/or hardware carry out user support in response to inquiries from users in case of failure of a computer system and/or installation of an application, and so on.

However, there is a disadvantage in that there is a case where it is difficult for a manufacturer to take accurate measures and/or give user support because the manufacture failed accurately to recognize or confirm information about hardware and software of the user's computer system in case of failure and/or setup of the computer system, installation of an application, and so on.

### SUMMARY OF THE INVENTION

Accordingly, it is an object of this invention to provide a server for supporting computer users, a system for recognizing configurations, a system for supporting computer users, a method for recognizing configurations and a method for supporting computer users, in which proper measures and/or user support can be accurately and promptly carried out by accurately and promptly recognizing a configuration of software and/or hardware of a user's computer system which is required for proper measures and/or user support in case of failure and/or setup of the computer system, installation of an application, and so on.

According to the first feature of the invention, a server for supporting computer users, which carries out user support in accordance with information about a user's computer system, comprises user's information editing processing means for editing information about a configuration of software and/or hardware of a user's computer system and user's information storing means for storing the information about the configuration of the software and/or hardware of each user's computer system which is edited by the user's information editing processing means, wherein the user's information editing processing means generates support information about the user's computer system in accordance with the information of the configuration of the software and/or hardware of each user's computer system which is stored by the user's information storing means and information about inquiries from the user.

According to the second feature of the invention, a system for recognizing configurations, which is a system for recognizing configurations of software and/or hardware of computer systems, comprises configuration information extracting means for extracting information about a configuration of software and/or hardware of a computer system and configuration information storing means for storing the information about the configuration of the software and/or hardware of the computer system which is extracted by the configuration information extracting means.

According to the third feature of the invention, a system for supporting computer users, which carries out user support in accordance with information about a user's computer system, comprises a server for supporting computer users which provides support information about a user's computer system, a computer system for which the support information is provided by the server for supporting computer users, a network which enables the server for supporting computer users and the computer system to communicate to each other by connecting both of them, wherein the server for supporting computer users is the above-mentioned server for supporting computer users and the computer system comprises the above-mentioned system for recognizing configurations.

According to the forth feature of the invention, a method for recognizing configurations, which is a method for recognizing configurations of software and/or hardware of computer systems, comprises the steps of (A) extracting information about a configuration of software and/or hardware of a computer system and (B) storing the extracted information about the configuration of the software and/or hardware of the computer.

According to the fifth feature of the invention, a method for supporting computer users, which carries out user support in accordance with information about a user's computer system, comprises the steps of (A) extracting information about a configuration of software and/or hardware of a user's computer system in response to an inquiry by the user, (B) generating support information in accordance with the extracted information about the configuration of the software and/or hardware and (C) providing the support information for the user.

### BRIEF DESCRIPTION OF THE DRAWINGS

The invention will be described in more detail in conjunction with the appended drawings, wherein:

FIG. 1 is a diagram showing an example of a system for supporting computer users according to the present invention;

FIG. 2 is a diagram showing an example of a system for recognizing configurations according to the present invention;

FIG. 3 is a diagram showing a server for supporting computer users according to the present invention;

FIG. 4 is a flowchart showing the process of a method for recognizing configurations according to the present invention; and

FIG. 5 is a flowchart showing the process of a method for supporting computer users according to the present invention.

### DETAILED DESCRIPTION OF THE PREFERRED EMBODIMENTS

Referring to accompanying drawings, a server for supporting computer users, a system for recognizing configurations, a system for supporting computer users, a method for recognizing configurations and a method for supporting computer users in the preferred embodiment according to the present invention will be explained as follows.

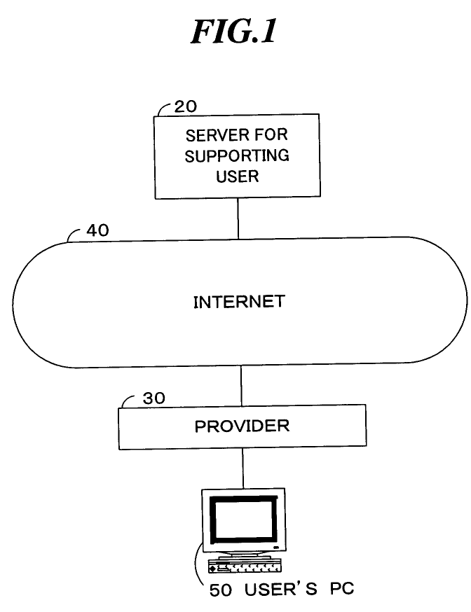

FIG. 1 is a diagram showing an example of a system for supporting computer users according to the present invention. In FIG. 1, the system for supporting computer users comprises user's personal computer (PC) 50 which becomes an object of support information, server 20 for supporting computer users which provides support information of user's PC 50, Internet 40 which enables user's PC 50 and server 20 for supporting computer users to communicate to each other by connecting both of them and provider 30 which connects user's PC 50 with Internet 40.

And, information about a configuration of software and/or hardware of each user's computer system and information about inquiries by a user are compiled through Web pages.

Alternatively, information about a configuration of software and/or hardware of each user's computer system and information about inquiries by a user are compiled by electronic mails.

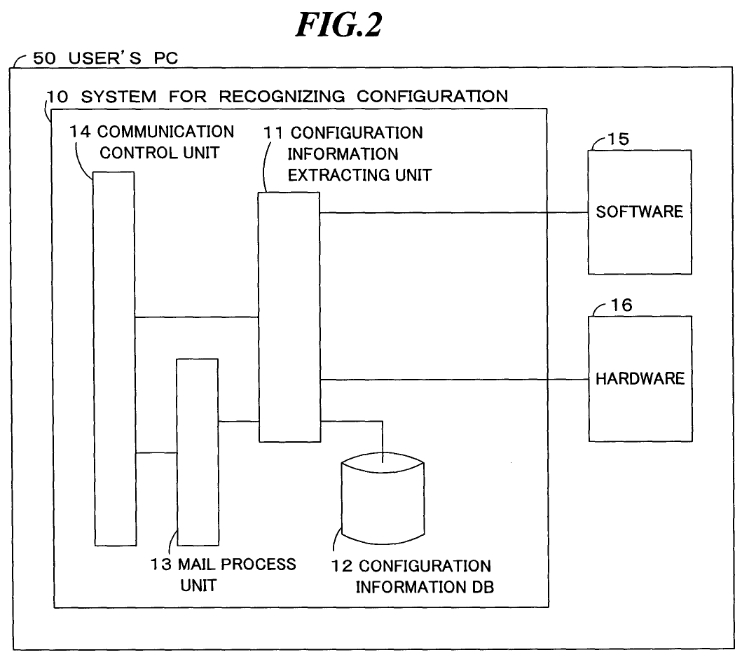

FIG. 2 is a diagram showing an example of a system for recognizing configurations according to the present invention. In FIG. 2, the system for recognizing configurations comprises configuration information extracting unit 11 which is installed to user's PC 50 and extracts information about a configuration of software 15 and/or hardware 16 in the user's PC 50, configuration information database 12 for storing the information about the configuration of the software and/or hardware extracted by configuration information extracting unit 11, mail processing unit 13 for generating an electronic mail including the information about the configuration of the software and/or hardware stored by configuration information database 12 and communication controlling unit 14 which is connected a network and gets communication under control.

And, configuration information extracting unit 11 extracts a formal name of an operating system, a service pack and a build number, which are included in the information about the configuration of the software of user's PC 50, with the aid of Windows application programming interface.

And more, configuration information extracting unit 11 extracts information about a version of Internet Explorer, which is included in the information about the configuration of the software of user's PC 50, from a registry of Internet Explorer.

Moreover, configuration information extracting unit 11 extracts information about applications installed in user's PC 50, which is included in the information about the configuration of the software of user's PC 50, from listed items of addition and deletion of applications which are stored in a registry.

Moreover, configuration information extracting unit 11 extracts information about resident applications, which is included in the information about the configuration of the software of user's PC 50, with the aid of ToolHelp and PSAPI.DLL.

Moreover, configuration information extracting unit 11 extracts information about environment, which is included in the information about the configuration of the software of user's PC 50, with the aid of Windows application programming interface.

Moreover, configuration information extracting unit 11 extracts file information about program files and common files, which is included in the information about the configuration of the software of user's PC 50, with the aid of Windows application programming interface.

Moreover, configuration information extracting unit 11 extracts each information about a type of a drive, a file system, a total capacity of a hard disk and a storage and an idle capacity of a hard disk and a storage, which are included in the information about the configuration of the hardware of user's PC 50, with the aid of Windows application programming interface.

Furthermore, configuration information extracting unit 11 extracts information about a partition of a file of Boot.ini, which is included in the information about the configuration of the hardware of user's PC 50, and information about an operating system, which is included in the information about the configuration of the software of user's PC 50, from the file of Boot.ini.

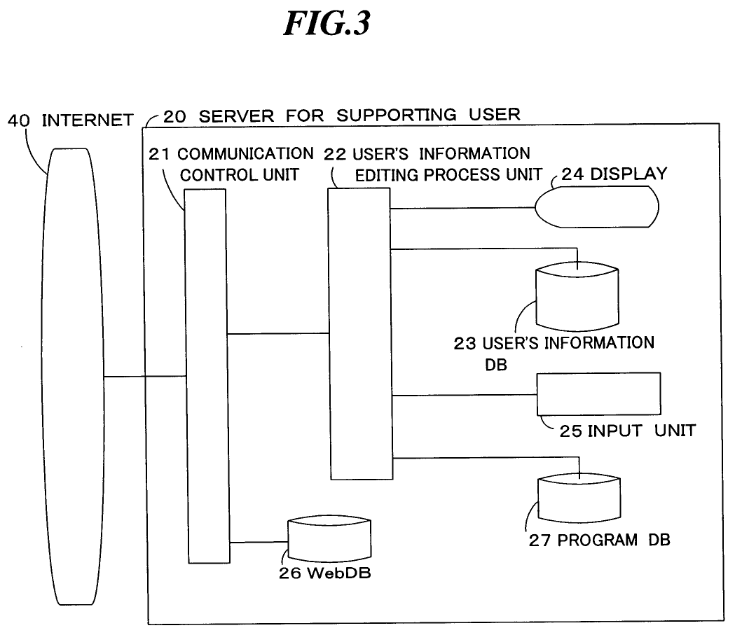

FIG. 3 is a diagram showing a server for supporting computer users according to the present invention. Server 20 for supporting computer users is connected with Internet 40 and comprises communication controlling unit 21 for receiving information about a configuration of software and/or hardware of user's PC 50, user's information editing processing unit 22 for editing the information about the configuration of the software and hardware of user's PC 50 and for generating support information about a user's computer system in accordance with the information about the configuration of the software and/or hardware of user's PC 50 and information about inquiries by the user, user's information database 23 for storing the information about the configuration of the software and/or hardware of user's PC 50 which is edited by user's information editing processing unit 22 and the support information, program database 27 for storing program for extracting information about configurations which is employed in extracting information about a configuration of software and/or hardware of a computer system, inputting unit 25 for inputting inquiries by users and so on, displaying unit 24 for displaying information about a configuration of software and/or hardware and support information, and Web database 26 for storing contents of Web pages which are provided for user's PC 50.

And, the program for extracting information about configurations which is stored by program database 27 is provided so as to be downloaded by user's PC 50 by user's information editing processing unit 22.

And more, the program for extracting information about configurations is provided on a Web page.

Moreover, the support information is provided on a Web page, or is provided in a condition where it is attached to an electronic mail.

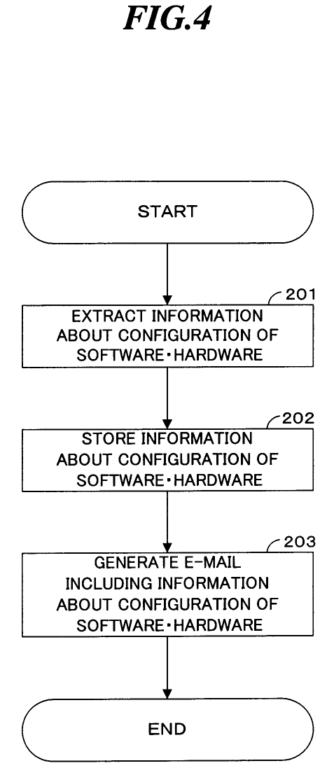

FIG. 4 is a flowchart showing the process of a method for recognizing configurations according to the present invention. In FIG. 2 and FIG. 4, first of all, configuration information extracting unit 11 extracts information about a configuration of software 15 and/or hardware 16 of user's PC 50 (in the step 201).

Then, the extracted information about the configuration of the software 15 and/or hardware 16 is stored by configuration information database 12 (in the step 202).

Next, an electronic mail including the information about the configuration of the software 15 and/or hardware 16 which is stored by configuration information database 12 is generated (in the step 203).

At this point, a formal name of an operating system, a service pack and a build number are extracted as information about software with the aid of Windows application programming interface by the step 201.

And, information about a version of Internet Explorer is extracted as information about software from a registry of Internet Explorer by the step 201.

And more, information about applications installed in a computer system is extracted as information about software from listed items of addition and deletion of applications which are stored in a registry by the step 201.

And more, information about resident applications is extracted as information about software with the aid of ToolHelp and PSAPI.DLL by the step 201.

Moreover, information about environment is extracted as information about software with the aid of Windows application programming interface by the step 201.

Moreover, with the aid of Windows application programming interface, file information about program files and common files is extracted as information about software and each information about a type of a drive, a file system, a total capacity of a hard disk and a storage and an idle capacity of a hard disk and a storage is extracted as information about hardware, by the step 201.

Moreover, from a file of Boot.ini, information about a partition is extracted as information about hardware and information about an operating system is extracted as information about software, by the step 201.

Furthermore, a name, a model number and/or the condition of connection with a network on each equipment connected with user's PC 50 are extracted as information about hardware by the step 201.

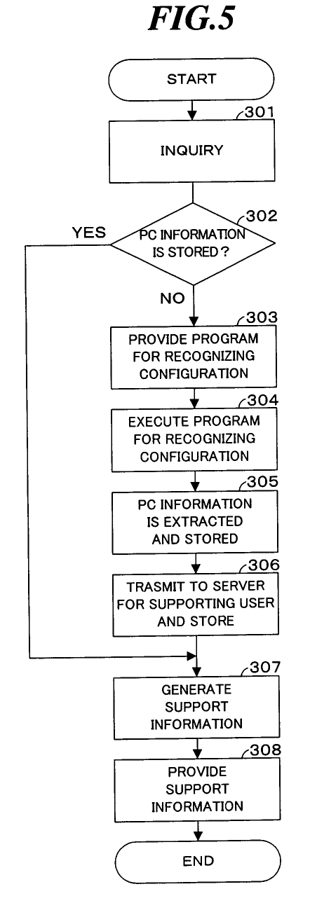

FIG. 5 is a flowchart showing the process of a method for supporting computer users according to the present invention. In FIG. 1 to 5, in response to inquiries from users over a facsimile, a telephone, an electronic mail and a Web page (in the step 301), whether information about a configuration of software and/or hardware of user's PC 50 is stored or not is confirmed (in the step 302).

If the information about the configuration of the software and/or hardware of user's PC 50 is not stored (in the step 302), a program for recognizing configurations, which is employed in extracting information about a configuration of software and/or hardware, is provided so as to be downloaded by user's PC 50 (in the step 303).

In user's PC 50, when configuration information extracting unit 11 executes the program for recognizing configurations (in the step 304), information about a configuration of software and/or hardware is extracted and stored by configuration information database 12 (in the step 305).

The information about the configuration of the software and/or hardware stored by configuration information database 12 is transmitted to server 20 for supporting computer users and is stored by user's information database 23 (in the step 306).

User's information editing processing unit 22 generates support information in accordance with the information about the configuration of the software and/or hardware of user's PC 50 and information about inquiries (in the step 307), the support information is provided for user's PC 50 over a telephone, a facsimile, an electronic mail and a Web page (in the step 308).

Then, in the step 306, the information about the configuration of the software and/or hardware of user's PC 50 can be compiled through a Web page or an electronic mail.

As mentioned above, according to the server for supporting computer users, the system for recognizing configurations, the system for supporting computer users, the method for recognizing configurations and the method for supporting computer users of the present invention, a configuration of software and/or hardware of a user's computer system which is required for proper measures and/or user support in case of failure and/or setup of the user's computer system, installation of an application, and so on, is accurately and promptly recognized, so that proper measures and/or user support can be accurately and promptly carried out.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A server for supporting computer users, which carries out user support in accordance with information about a user's computer system, comprising:
user's information editing processing means for editing information about a configuration of software and hardware of a user's computer system; and
user's information storing means for storing the information about the configuration of the software and hardware of each user's computer system, which is edited by said user's information editing processing means, wherein
said user's information editing processing means generates support information about said user's computer system in accordance with the information of the configuration of the software and hardware in each user's computer system which is stored by said user's information storing means and information about inquiries from a user.

2. The server for supporting computer users of claim 1, further comprises,
program storing means for storing a program for extracting information about configurations which carries out extraction of information about a configuration of software and hardware of a computer system.

3. The server for supporting computer users of claim 2, wherein
said program for extracting information about configurations which is stored by said program storing means is provided so as to be downloaded by said computer system by said user's information editing processing means.

4. The server for supporting computer users of claim 3, wherein
said program for extracting information about configurations is provided on a Web page.

5. The server for supporting computer users of claim 1, wherein
said support information is provided on a Web page.

6. The server for supporting computer users of claim 1, wherein
said support information is provided in a condition where it is attached to an electronic mail.

7. A system for recognizing configurations, which is a system for recognizing configurations of software and hardware of computer systems, comprising:
configuration information extracting means for extracting information about a configuration of software and hardware of a computer system; and
configuration information storing means for storing said information about the configuration of the software and hardware of the computer system that is extracted by said configuration information extracting means.

8. The system for recognizing configurations of claim 7, further comprises,
mail processing means for generating an electronic mail including said information about the configuration of the software and hardware of the computer system that is stored by said configuration information storing means.

9. The system for recognizing configurations of claim 7, wherein
said information about the configuration of the software of the computer system includes a formal name of an operating system, a service pack and a build number.

10. The system for recognizing configurations of claim 9, wherein
said configuration information extracting means extracts said formal name of the operating system, said service pack and said build number with the aid of Windows application programming interface.

11. The system for recognizing configurations of claim 7, wherein
said information about the configuration of the software of the computer system includes information about a version of Internet Explorer.

12. The system for recognizing configurations of claim 11, wherein
said configuration information extracting means extracts said information about the version of Internet Explorer from a registry of Internet Explorer.

13. The system for recognizing configurations of claim 7, wherein
said information about the configuration of the software of the computer system includes information about applications installed in the computer system.

14. The system for recognizing configurations of claim 13, wherein
said configuration information extracting means extracts said information about the applications installed in the computer system from listed items of addition and deletion of applications that are stored in a registry.

15. The system for recognizing configurations of claim 7, wherein
said information about the configuration of the software of the computer system includes information about resident applications.

16. The system for recognizing configurations of claim 15, wherein
said configuration information extracting means extracts said information about the resident applications with the aid of ToolHelp and PSAPI.DLL.

17. The system for recognizing configurations of claim 7, wherein
said information about the configuration of the software of the computer system includes information about environment.

18. The system for recognizing configurations of claim 17, wherein
said configuration information extracting means extracts said information about the environment with the aid of Windows application programming interface.

19. The system for recognizing configurations of claim 7, wherein
said information about the configuration of the software of the computer system includes file information about program files and common files.

20. The system for recognizing configurations of claim 19, wherein
said configuration information extracting means extracts said file information about the program files and the common files with the aid of Windows application programming interface.

21. The system for recognizing configurations of claim 7, wherein
said information about the configuration of the hardware of the computer system includes each information about a type of a drive, a file system, a total capacity of a hard disk and a storage and an idle capacity of a hard disk and a storage.

22. The system for recognizing configurations of claim 21, wherein
said configuration information extracting means extracts said each information about the type of the drive, the file system, the total capacity of the hard disk and the storage and the idle capacity of the hard disk and the storage with the aid of Windows application programming interface.

23. The system for recognizing configurations of claim 7, wherein
said information about the configuration of the hardware of the computer system includes information about a partition of a file of Boot.ini, and
said information about the configuration of the software of the computer system includes information about an operating system.

24. The system for recognizing configurations of claim 23, wherein
said configuration information extracting means extracts said information about the partition and said information about the operating system from said file of Boot.ini.

25. The system for recognizing configurations of claim 7, wherein
said information about the configuration of the hardware of the computer system includes a name and a model number of each equipment connected with the computer system.

26. The system for recognizing configurations of claim 7, wherein
said information about the configuration of the hardware of the computer system includes the condition of connection with a network.

27. The system for recognizing configurations of claim 7, wherein
said configuration information extracting means executes a program for extracting information about configurations which executes extraction of said information about the configuration of the software and hardware of the computer system.

28. A system for supporting computer users, which carries out user support in accordance with information about a user's computer system, comprising:
a server for supporting computer users which provides support information about a user's computer system;
a computer system for which the support information is provided by said server for supporting computer users; and
a network which enables said server for supporting computer users and said computer system to communicate to each other by connecting both of them,
wherein
said server for supporting computer users is any server for supporting computer users which is described within claims 1 to 6, and
said computer system comprises any system for recognizing configurations, which is described within claims 7 to 27.

29. The system for supporting computer users of claim 28, wherein
information about a configuration of software and hardware of each said user's computer system and information about inquiries from a user are compiled through Web pages.

30. The system for supporting computer users of claim 28, wherein
information about a configuration of software and hardware of each said user's computer system and information about inquiries from a user are compiled by electronic mails.

31. A method for recognizing configurations, which is a method for recognizing configurations of software and hardware of computer systems, comprising the steps of:
(a) extracting information about a configuration of software and hardware of a computer system; and
(b) storing said extracted information about the configuration of the software and hardware of the computer system.

32. The method for recognizing configurations of claim 31, further comprises the step of,
(c) generating an electronic mail including said information about the configuration of the software and hardware of the computer system that is stored.

33. The method for recognizing configurations of claim 31, wherein
said step of (a) comprises the step of extracting a formal name of an operating system, a service pack and a build number as the information about the configuration of the software of the computer system with the aid of Windows application programming interface.

34. The method for recognizing configurations of claim 31, wherein
said step of (a) comprises the step of extracting information about a version of Internet Explorer as the information about the configuration of the software of the computer system from a registry of Internet Explorer.

35. The method for recognizing configurations of claim 31, wherein
said step of (a) comprises the step of extracting information about applications installed in the computer system as the information about the configuration of the software of the computer system from listed items of addition and deletion of applications which are stored in a registry.

36. The method for recognizing configurations of claim 31, wherein
said step of (a) comprises the step of extracting information about resident applications as the information about the configuration of the software of the computer system with the aid of ToolHelp and PSAPI.DLL.

37. The method for recognizing configurations of claim 31, wherein
said step of (a) comprises the step of extracting information about environment as the information about the configuration of the software of the computer system with the aid of Windows application programming interface.

38. The method for recognizing configurations of claim 31, wherein
said step of (a) comprises the step of extracting file information about program files and common files as the information about the configuration of the software of the computer system with the aid of Windows application programming interface.

39. The method for recognizing configurations of claim 31, wherein
said step of (a) comprises the step of extracting each information about a type of a drive, a file system, a total capacity of a hard disk and a storage and an idle capacity of a hard disk and a storage as the information about the configuration of the hardware of the computer system with the aid of Windows application programming interface.

40. The method for recognizing configurations of claim 31, wherein
said step of (a) comprises the step of extracting information about a partition as the information about the configuration of the hardware of the computer system and information about an operating system as the information about the configuration of the software of the computer system from a file of Boot.ini.

41. The method for recognizing configurations of claim 31, wherein
said step of (a) comprises the step of extracting a name and a model number of each equipment connected with the computer system as the information about the configuration of the hardware of the computer system.

42. The method for recognizing configurations of claim 31, wherein
said step of (a) comprises the step of extracting a condition of connection with a network as the information about the configuration of the hardware of the computer system.

43. A method for supporting computer users, which carries out user support in accordance with information about a user's computer system, comprising the steps of:
(a) extracting information about a configuration of software and hardware of a user's computer system in response to inquiries by a user;
(b) generating support information in accordance with the extracted information about the configuration of the software and hardware of the user's computer system; and
(c) providing the support information for the user.

44. The method for supporting computer users of claim 43, wherein
said step of (a) comprises the step of compiling the information about the configuration of the software and hardware of the user's computer system through a Web page.

45. The method for supporting computer users of claim 43, wherein
said step of (a) comprises the step of compiling the information about the configuration of the software and hardware of the user's computer system through an electronic mail.

46. The method for supporting computer users of claim 43, wherein
said step of (c) comprises the step of providing the support information for the user by using a Web page.

47. The method for supporting computer users of claim 43, wherein
said step of (c) comprises the step of providing the support information for the user by using an electronic mail.
